(19) United States
(12) Patent Application Publication
(10) Pub. No.: US 2008/0094636 A1
(43) Pub. Date: Apr. 24, 2008

(54) Fiber gas lasers and fiber ring laser gyroscopes based on these gas lasers

(75) Inventors: Wei Jin, Kowloon (CN); Xin Shi, Kowloon (CN)

Correspondence Address: The Hong Kong Polytechnic University, Suite 600, Mailbox #119, 1800 Diagonal Road, Alexandria, VA, 22314, US

(73) Assignee: The Hong Kong Polytechnic University, Hong Kong (HK)

(21) Appl. No.: 11/898,813

(22) Filed: Sep. 17, 2007

(30) Foreign Application Priority Data
Oct. 20, 2006 (CN) 200610135647.0

(51) Int. Cl. G01C 19/72; H01S 3/067

(52) U.S. Cl. 356/466; 356/460; 372/6

(57) ABSTRACT

This invention discloses to a type of fiber gas lasers and fiber ring laser gyroscopes based on these fiber gas lasers. The fiber gas lasers comprise of excitation gases, optical resonator and excitation source, etc. The optical resonator is made by connecting two selected arms of a single mode fiber coupler to the two ends of hollow-core fiber to form a ring resonator. The hollow-core of the fiber is filled with excitation gases to act as gain medium. The fiber laser is simple to construct, lower cost, and has adjustable size and good amplification performance. The fiber ring laser gyroscopes based on this novel type of gas lasers can be applied on robotics, automobile navigation, etc.

### TECHNICAL FIELD

This invention relates to a type of fiber lasers and fiber ring laser gyroscopes based on these lasers, in particular a type of fiber gas lasers and fiber ring laser gyroscopes based on such fiber gas lasers.

### BACKGROUND

Gyroscopes are devices that measure rotation in an inertial frame. Gyroscopes are applied widely around us, examples of applications include precise missile guidance, submarine navigation, artillery stabilization, engineering surveying positioning, guidance in oil drilling and controlling of robot movement. Even in our daily life, people unwittingly have benefited from the use of gyroscopes. For example, passengers can fly comfortably in a airplane thanks to the attitude heading reference system that uses gyroscopes. Gyroscopes are used as core components to reduce the swing of high-speed train especially around a turning point. In the present, Global Positioning System (GPS) are popularly used in car navigation and location, but GPS is passive and, only when it is combined with gyroscopes, active vehicle guidance and automatic driving are capable of initiative.

Gyroscopes have many types, including electromechanical, laser, fiber, piezoelectric and MEMS ones. Among them, the operating principle of optical gyroscope is Sagnac effect. Sagnac effect is the phenomenon that optical path difference or phase difference between two counter-propagating, which are generated from the same source and travel through the same optical path but opposite directions, is proportional to angular velocity relative to an inertia frame.

One important type of optical gyroscopes is the ring laser gyro (RLG). The main component in a RLG is the laser. A laser is generally composed of three parts: gain medium, an excitation (pump) system and an optically resonating cavity. The laser in a RLG adopts a ring cavity structure. Laser gyro can be divided into external cavity and intra-cavity structures as shown in FIG. 1a and FIG. 1b respectively.

An external cavity RLG is shown in FIG. 1a. A He—Ne discharge tube (gain tube or amplifier) is placed within a ring resonator cavity formed by three mirrors. The He—Ne amplifier enables bi-directional lasing within the cavity. In the presence of rotation, the optical paths and hence the frequencies of the counter-propagating lasing beams will be different and relationship between the frequency difference and angular velocity is given by:

$$Δ f = {f}_{cw} - {f}_{ccw} = \frac{4 A}{λ P} Ω \qquad ( 1 )$$

Where λ is the laser wavelength, f_{cw} and f_{ccw} are respectively the frequencies of the clockwise and counter-clockwise lasing beams. A is the area and P is the perimeter of the optical path, and Ω is the rotation rate.

In the intra-cavity configuration as shown in FIG. 1b, the gain medium fills in the whole ring cavity that is fabricated by drilling in quartz or other low expansion materials to form ring capillary channel for the purpose of storing excitation gases; auxiliary holes are also drilled for inserting electrodes. The capillary channel also serves as optical path of the ring resonator. Dielectric mirrors are glued to highly-quality polished surfaces of the cavity to form a low loss resonator. In the intra-cavity RLG, the relationship between the frequency difference of the counter-propagating lasing beams and the angular velocity is also given by equation (1).

To achieve high accuracy, for both external and intra-cavity RLGs, it is necessary to precisely control the cavity length to keep the average frequency (f_{cw}+f_{ccw})/2 at the point of maximum gain. It needs to use a structure with double anodes and a common cathode to eliminate Langmuir flow effect on the performance of gyroscopes. It also needs to use a special prism to combine the counter-propagating laser beams to generate interference fringes from which the frequency difference between the two laser beams can be obtained by using a photo-detector and subsequent electric circuitry.

RLGs, compared to their mechanical counterparts, have the advantages of no moving parts and hence relatively insensitive to a number of error sources such as shock and vibration and require shorter time for error-correction. In addition, RLGs have large dynamic range (from below 0.01°/hr to over 1000°/hr) and digital (frequency) output. However, the cost of a manufacturing a RLG is high because of the high quality mirrors required and special technology needed for manufacturing the cavity, which is not commonly used in other fields.

Another important type of optical gyroscope is the interferometric fiber optic gyroscope (IFOG). This type of gyros is shown in FIG. 2. The two beams travel through the same fiber coil but along opposite directions. When the gyro rotates, there will be optical path difference (phase difference or also called phase shift). The phase difference between the two beams and its angular velocity is related to rotation rate by:

$$Δφ = \frac{8 π A N}{λ c} Ω = \frac{2 π L D}{λ c} Ω \qquad ( 2 )$$

Where L is the length of the fiber, D is the diameter of the fiber coil, N is the number of turns in the fiber coil. Because of the light interference, optical intensity at detector (D) varies with phase difference, and it can be used to measure angular velocity. An IFOG typically uses a broadband low-coherence light source. This, coupled with the use of a good quality polarizer, a polarization maintaining fiber, special-coil-winding and magnetic shielding techniques, substantially reduces the noises and errors due to reflection, scattering, the Kerr effect, the polarization effect, the time-dependent thermal effect and external magnetic field effects. Like RLGs, IFOGs have the advantage of no moving parts and hence resistance to shock and acceleration. In addition, IFOGs can also have the advantage of being able to use the existing components developed in fiber optic communication industry and hence low cost. However, as the sensitivity for rotation in detection is proportional to the length of the fiber coil, to achieve high detection resolution, long length single mode optical fibers of hundreds of meters to kilometers is typically required in an IFOG. The output of IFOG is an analog signal and the output light intensity has a non-linear (sine or cosine) relationship to angular velocity, and this limits linear measuring range of IFOG. To achieve a linear output in over a relatively larger rotation range, feedback control is needed to introduce additional phase shift to compensate phase shift due to rotation, i.e., the gyro is working in a closed-loop state. In addition, the scale factor between phase difference and angular velocity, as can be seen from equation (2), is inversely proportional to wavelength; as the wavelength of a broadband light source is hard to define and not very stable, this leads to the instability in the gyro scale factor.

### SUMMARY OF THE INVENTION

In view of the complexity and the difficulty existed in manufacturing RLG, and the non-preferred analog output and the instability in the scale factor of IFOG, the purpose of this invention is to provide a type of fiber ring laser gyroscopes that combines the advantages of both RLG and IFOG, while avoiding their shortcomings.

To achieve this purpose, this invention provides a type of fiber gas laser comprising of excitation gases, optical resonator and excitation source. The optical resonator is made of hollow-core fiber and a single-mode fiber coupler; two arms of the fiber coupler are connected to the two ends of the hollow-core fiber and the hollow-core is filled with excitation gases to act as gain medium.

According to the gas laser of this invention, the diameter of the hollow-core of the fiber is between 5˜200 μm.

According to the gas laser of this invention, the said hollow-core fiber can be one of the following types: light guiding capillaries, hollow-core Bragg fibers, hollow-core Fresnel fibers and hollow-core photonic bandgap fibers.

According to the gas laser of this invention, the excitation gases are a mixture of helium and neon gases.

According to the gas laser of the invention, the hollow-core fiber has side-opened holes, which are connect to gas storage chambers that surround the hollow-core fibers, to allow the gas mixture to go through from the gas chambers to the hollow-core and vise versa.

According to the gas laser of the invention, there are gaps at the joints between the hollow-core and the solid-core single mode fibers, and the gaps are surrounded by gas chambers. The gaps have dimensions equal to or smaller than core diameter of the fibers and serve as channels for gas to flow between the hollow core and the gas chamber.

According to the gas laser of the invention, the hollow-core fiber forming the resonator comprising of two sections joint together inside the gas chamber. This is a gap, at the joint, between the two sections, and the gap has a dimension equal to or smaller than the diameter of the hollow fiber core. The gap serves as a channel for gas to flow between the hollow core and gas chamber.

According to the gas laser of the invention, the excitation source is DC discharge excitation device, which includes cathode and anode inside the gas chamber.

According to the gas laser of the invention, the excitation source can also be a combination of DC and radio frequency (RF) excitation.

According to the gas laser of the invention, the excitation source is RF induction excitation device which includes RF emission source and one or more induction coils around hollow-core fiber.

According to the gas laser of the invention, the excitation source is capacitive coupled RF device which includes at least one pair of slab electrodes which sandwich the hollow-core fiber in the middle.

The invention also provides a fiber ring laser gyro which includes the gas laser described above.

According to the fiber ring laser gyro of the invention, it also includes resonator cavity-length control device which is composed of fiber (length) modulator, feedback controller and fiber (cavity length) compensator.

According to the fiber ring laser gyro of the invention, one piezoelectric ceramic component with fiber wound on it can serve as both the fiber modulator and fiber compensator.

According to the fiber ring laser gyro of the invention, the fiber modulator and the fiber compensator can be two different piezoelectric ceramic components with fibers wounded on them.

According to the fiber ring laser gyro of the invention, it includes beat frequency read-out system.

According to the fiber ring laser gyro of the invention, the beat frequency read out system includes a 3×3 fiber coupler and three photon detectors connected to three output ends of the coupler. The fiber gas laser in the invention uses hollow-core fiber filled with He—Ne gas mixture to serve as an optical waveguide as well as a discharge tube. It has good amplification performance, simple structure, low cost and is easy to fabricate.

Preliminary theoretical estimation shows that the shot-noise limited performance of the fiber ring laser gyro described in this invention is similar to IFOGs and the RLGs. However, the fiber ring laser gyro in this invention needs neither long length of fiber nor high quality mirrors and hence reduces the cost of the system. The length of fiber ring can be adjusted within certain range in accordance with performance expectation while maintaining the overall small size.

The fiber ring laser gyro in the invention has low cost, with performance adjustable from low, medium to high accuracy, and can be used in automatic navigation system, robot application, geological exploration, missile guidance and stabilization, oil-well drilling, tactical weapons guidance, rocket navigation systems etc.

### BRIEF DESCRIPTION OF THE DRAWINGS

FIG. 1a shows a schematic diagram of a typical external cavity ring laser gyro and FIG. 1b shows a schematic diagram of a typical intra-cavity ring laser gyro.

FIG. 2 shows a schematic diagram of a typical interferometric fiber optic gyroscope (IFOG).

FIG. 3 is a graph showing the first case of implementation of fiber gas laser.

FIG. 4 is a graph showing the second case of implementation of fiber gas laser.

From FIG. 5a to FIG. 5d are cross-sectional view graphs of several types of hollow-core fibers that may be used in this invention.

FIG. 6 is schematic diagram showing a beat-frequency read out set-up that uses a 3×3 fiber coupler and three photo detectors.

FIG. 7 is schematic diagram showing a laser cavity length control device of the invention.

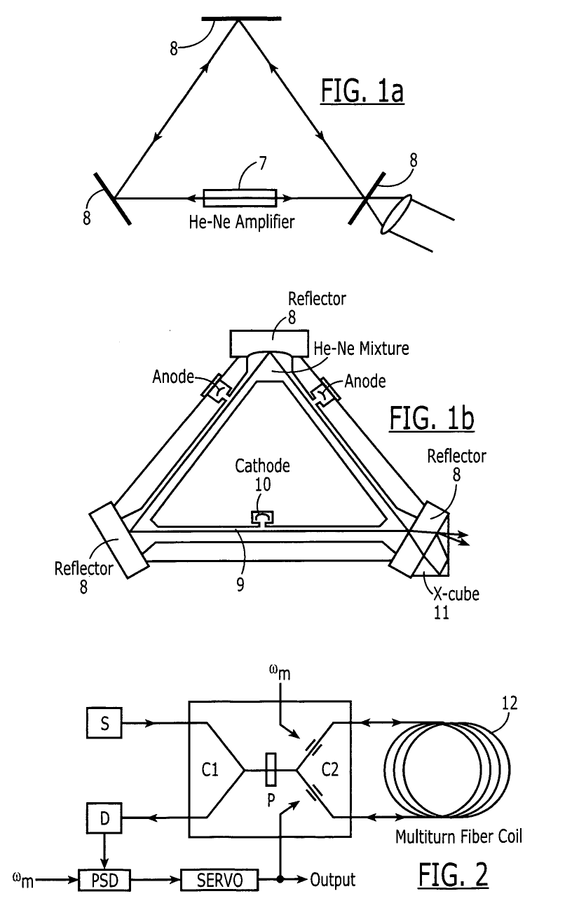

### DETAILED DESCRIPTION OF THE PREFERRED EMBODIMENT

In the following, detailed description will be provided by using examples and by referring to attached graphs.

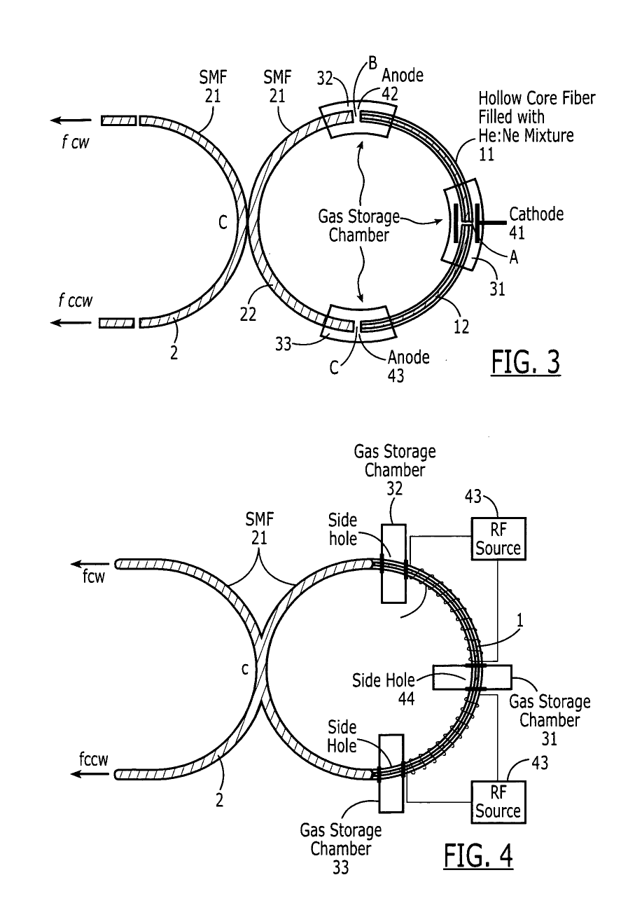

FIG. 3 is a graph showing the first implementation case of fiber gas laser.

According to the first implementation case of fiber gas laser of the invention, it includes excitation gases, optical resonator and excitation source. The optical resonator is a fiber ring made up of hollow-core fiber connected to the two arms of a single-mode fiber coupler by using a low loss connection technique. The hollow core is filled with excitation gases and serves as gain tube (discharge tube). The excitation source is a DC discharge device.

In detail, the ends of the two sections of hollow-core fiber 11, 12, which have approximately the same length, are connected to each other through a mounting device (not shown in the graph) while keeping a certain gap between them and this whole serves as the gain tube of the fiber gas laser. The hollow core of the fiber 11, 12 is filled with He—Ne gas mixture to serve as gain medium. The other ends of fibers 11, 12 are connected with the two branches 21, 22 of the single mode fiber coupler through two mounting devices (not shown in the graph) while keeping certain gaps between them and this forms a fiber ring cavity.

There are gas chambers 31, 32, and 33, which surround respectively the joints between hollow-core fibers 11 and 12, between the hollow-core fiber 11 and the solid core fiber 21, between the hollow-core fiber 12 and the solid core fiber 22. The joints are placed inside the gas chambers 31, 32, 33, respectively to allow gas flow between hollow core of fiber 11, 12 and gas chambers 31, 32, 33. The volumes of gas chambers 31, 32 and 33 are much larger than that of the hollow core of fiber 11, 12 and are used to regulate when the He—Ne gas mixture in the hollow-core of the fiber 11, 12 are excited, and stabilize the gas pressure within the hollow core fiber 11, 12.

To allow gas to flow between the hollow-core fiber 11, 12 and the gas chambers 31, 32, 33, in this implementation case small gaps A, B, and C are maintained between the hollow-core fiber 11 and 12, between the solid fiber 21 and the hollow core 11, and between the solid core fiber 22 and the hollow-core fiber 12, respectively. The sizes of the gaps A, B and C equal to or smaller than the diameter of the hollow-core. The gaps A, B and C serve as the channels to allow gas flow between gas chambers 31, 32, 33 and hollow core of the hollow-core fiber 11, 12. In this implementation case, multiple gas chambers 31, 32, 33 are used and the gas chambers 32, 33 are located symmetrically with respect to position of 31, this is helpful to balance the gas pressure inside hollow core and also minimize the Langmuir flow effect.

The DC discharge device includes a cathode 41 and two anodes 42, 43. As the core sizes of fiber 11, 12 are very small, it is difficult to put electrodes inside the hollow-tube. Therefore cathode 41 is located in gas chamber 31 and anodes 42, 43 are in gas chambers 32, 33 respectively.

The single mode fiber (SMF) coupler is made from solid-core fibers and the two arms of the fiber coupler 21, 22 of single mode fiber (SMF) directional coupler 2 are connected with hollow-core fiber 11, 12 to tap out the counter-propagation lasing beams. The SMF coupler 2 has a small coupling ratio, for example, 1:99. There exist connection loss and back reflection at the joints between the solid-core fibers 21, 22 and the hollow-core fiber 11, 12, such connection loss will not have substantive effect on the performance of hollow-core fiber gas laser, because the hollow-fiber gain tube provides sufficient amplification that compensates the loss. Further more, such connection loss and back reflection may be reduced by using the existing fiber splicing technologies. For example, by keeping a certain angle at the fiber joint, between the solid core fiber 21, 22 and the hollow-core 11, 12, the back-reflected light can be substantially reduced.

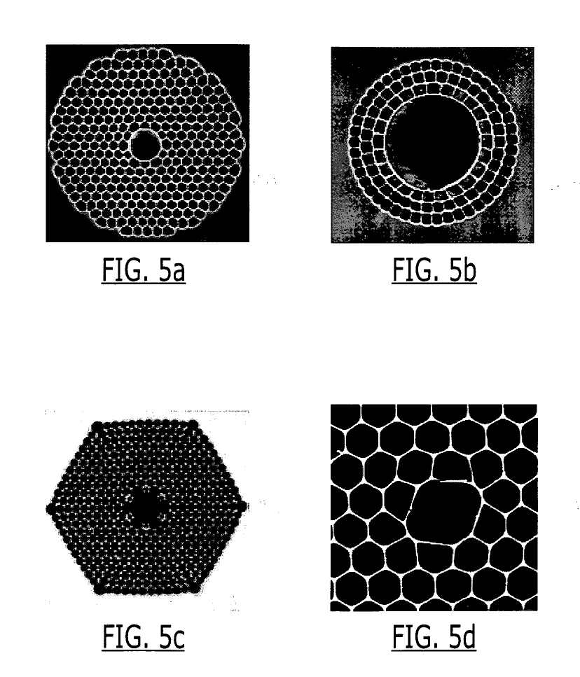

FIG. 4 is a graph showing the second implementation case of fiber gas laser.

According to the second implementation case of the invention, the fiber gas laser includes excitation gases, optical resonator and excitation source. The optical resonator is ring cavity made by jointing hollow-core fiber 1 with the two arms 21, 22 of the SMF fiber coupler 2 with a low loss connection technique. The hollow core of the hollow core fiber 1 is filled with excitation gases and serves as gain tube (discharge tube). The excitation source is a RF discharge device.

In detail, the hollow-core of fiber 1 is filled with He—Ne mixture (gain medium) to serve as gain tube of fiber gas laser. The hollow-core fiber 1 also serves as discharge tube. The two ends of the hollow-core fiber 1 are connected to two solid-core fiber branches 21, 22 of the SMF coupler 2 without any spacing between them. For example, the connection can be fusion splicing or jointing with adhesive, which ensure that there are no moving parts in the fiber ring.

Gas chamber 31 is placed in the middle of the hollow-core fiber 1 and Gas chambers 32, 33 are placed respectively near the joints between the hollow-core fiber 1 and the solid core fibers 21, 22. There are side holes (not shown) in the sections of fiber 1, which are inside the gas chambers 31, 32, 33. These side holes allow gas to flow between the hollow core of the hollow-core fiber 1 and the gas chambers 31, 32, 33.

The single mode fiber coupler 2 has the same structure as that in the first implementation case.

The RF discharge device includes RF source 45, two induction coils 44 that are wound around hollow-core fiber 1. Such an arrangement of the induction coils is to couple RF energy into gas mixture. Although two induction coils are shown in FIG. 4, obviously, the coils can be one or more than two.

The RF discharge device can also be capacitative coupling device, adopting one or more pairs of electrode slabs sandwiching the hollow-core fiber 1.

The excitation device can also be a combination of DC and RF excitation.

As described above, the first and second implementation cases both use the hollow core of the fiber as gain tube (discharge tube). Hollow-core fiber can have many types, including low loss light guiding capillary, hollow core photonic band gap (PBG) fiber, hollow-core Fresnel fibers and hollow-core photonic bandgap (PBG) fibers. FIGS. 5a, 5b, 5c, 5d are the cross-sectional view of several types of hollow-core PBG fibers. Hollow-core PBG fibers can be fabricated by stacking silica capillaries periodically in a hexagonal close-packed array and removing 7, 19 or more capillary cells at the center. Current hollow-core fibers have achieved a loss of smaller than 0.5 dB/m and hence it is easy to form a low loss ring cavity. Provided there is appropriate gain in the He—Ne amplifier, laser light can be produced.

As described in two implementation cases above, fiber amplifiers working at 0.6328 μm or 1.15 μm can be made when the hollow core of the fiber is filled with He—Ne mixture and hence waveguide He—Ne lasers may be constructed. Hollow-core fibers having core size in the range from 5 μm to 200 μm are all suitable to be used in two implementation cases above. By choosing appropriate He:Ne gas mixing ratio, total gas pressure, discharge configuration and other parameters, gain of around 1 10 dB/m can be achieved. The loss of the hollow-core PBG fiber does not increase significantly even when it is bent or coiled down to a diameter of a few centimeters, this would allow the construction of compact gas lasers and hence compact fiber ring laser gyroscopes.

Based on the fiber gas lasers in the two implementation cases, fiber ring laser gyros can be constructed. Such fiber ring laser gyros have the advantages of simple production process, small and adjustable size, while achieving detection accuracy similar to that of conventional RLGs.

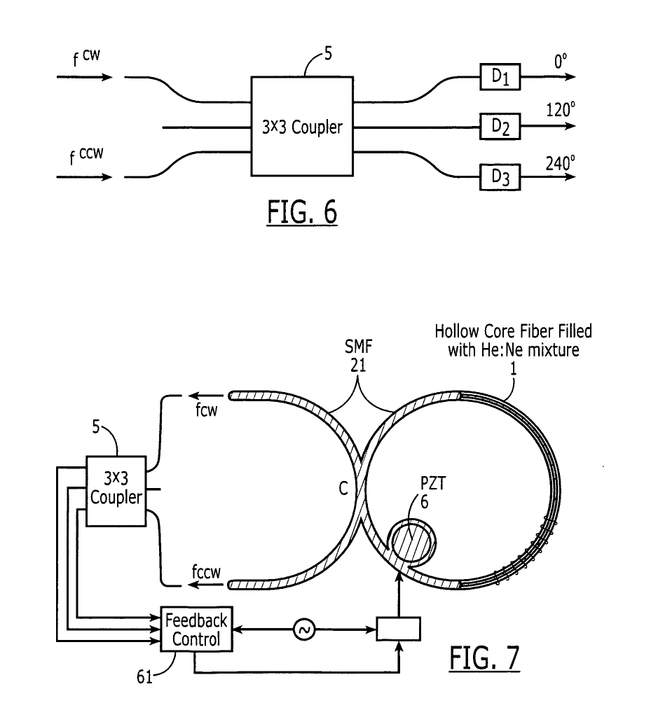

FIG. 6 shows that beat frequency read-out system of the fiber ring laser gyro in the invention. This system includes a 3×3 coupler 5 and three photo detectors D1, D2 and D3 that are connected to the three output ends of the 3×3 coupler 5. The coupler 5 which has an equal splitting ratio for the three branches. The three photo detectors produce, in their outputs, three electrical signals that have different phases but the same frequency equaling to the beat frequency Δf=f_{cw}−f_{ccw} between the two counter-propagating beam in the ring laser, and hence can be used to read the beat frequency. With the use of a set of three signals with different phases instead of a single phase signal, the polarity of rotation can be determined. Alternatively, one may read out the beat frequency by coherently combining the two counter-propogating lasing beams with a small angle, a similar principle as that used in conventional bulk RLGs, to allow the detection of moving fringes and hence the rate and the polarity of rotation.

Similar to conventional bulk RLGs, it is necessary to adjust the cavity length of the laser to keep the average frequency (f_{cw}+f_{ccw})/2 at the point of maximum gain. Therefore the fiber ring laser gyro in the invention also includes a frequency stabilization device, which is also called cavity length control device.

As shown in FIG. 7, the fiber ring laser gyro of the invention includes cavity-length control device. This device includes a fiber modulator, a fiber compensator and a feedback controller.

The Fiber modulator and fiber compensator can be made by winding fibers around two separate piezoelectric (ceramic) transducers; the size of piezoelectric transducer component varies with the applied external voltage, causing variation in the length and refractive index of the SMF or the hollow-core fiber and ultimately variation in the optical path or phase of light traveling in the fibers. By applying a small dithering signal (e.g., a sinusoidal AC signal with a frequency of 30 kHz) to the piezoelectric transducer that forms the fiber modulator, the output intensities of two counter-propagation laser beams can be modulated. Phase-sensitive detection is used demodulate the output signals and an error signal is generated to drive fiber compensator to control the resonator cavity-length and hence achieve frequency stabilization. Fiber modulator and fiber compensator can also be made from the same piezoelectric transducer by winding by fibers around it, and dithering signal and error compensating signal can be applied to this same piezoelectric transducer. In the implementation case shown in FIG. 7, the fiber modulator and fiber compensator are using the same piezoelectric transducer 6 and the piezoelectric transducer 6 is connected to the feedback controller 61.

The fiber gas laser in the invention uses hollow-core fiber filled with He—Ne mixture gases to serve as optical waveguide and discharge tube. It has good amplification performance, simple structure, low cost and is easy to construct.

Preliminary theoretical estimation shows that the shot noise limited performance of the fiber ring laser gyro in the invention is similar to that of IFOGs and the conventional RLGs. However, the novel fiber ring laser gyro proposed in this invention needs neither long length of fiber nor high quality mirrors and hence can achieve cost reduction. The length of fiber ring can be adjusted within certain range in accordance with performance needs while maintaining the overall small size.

The fiber ring laser gyro of this invention has low cost, and can be designed to have different performance, and hence can be used in automatic navigation, the robot application, geological exploration, missile stability, oil well drilling, tactical weapons guidance, rocket navigation, etc.

What is claimed is:

1. A fiber gas laser apparatus comprising excitation gases, optical resonator, and on excitation source, wherein said optical resonator comprising hollow-core fiber and solid-core single-mode fiber coupler, wherein two arms of the solid-core single mode fiber coupler are connected to the two ends of said hollow-core fiber to form a resonating fiber ring, said hollow-core fiber being filled with excitation gases to act as gain medium.

2. The fiber gas laser apparatus of claim 1, wherein the core diameter of said hollow-core fiber is in the range of 5 to about 200 μm.

3. The fiber gas laser apparatus of claim 1, wherein said excitation gas is a mixture of helium and neon gases.

4. The fiber gas laser apparatus of claim 1, wherein the hollow-core fiber can be light guiding capillaries, hollow-core Bragg fibers, hollow-core Fresnel fibers and hollow-core photonic bandgap fibers.

5. The fiber gas laser apparatus of claim 1 wherein said there are gas storage chambers placed around the said hollow-core fiber and the sections of said hollow-core fiber inside the chamber have side-openings or holes to allow gas to flow from the hollow-core to the chamber, and vise versa.

6. The fiber gas laser apparatus of claim 1 wherein there are gas chambers placed around the joints between said hollow-core fiber and said solid core single mode fiber, with gaps at said joints, with their sizes equal to or smaller than core diameter of the fiber, wherein said gaps serve as the channel for gas to flow between said hollow core and said gas chambers.

7. The fiber gas laser apparatus of claim 6 wherein said hollow-core fiber comprises two sections of said fiber joint together, wherein said gaps serve as the channel for gas to flow between said hollow core and said gas chambers.

8. The fiber gas laser apparatus of claim 5, 6 or 7 wherein said the excitation source is DC discharge excitation device, comprising a cathode and an anode placed inside the gas chamber.

9. The fiber gas laser apparatus of claim 8 wherein said excitation source further comprises a RF discharge excitation device that is used in combination with the DC excitation device.

10. The fiber gas laser apparatus of claim 1 wherein said excitation source is RF excitation device comprising a RF emission source and one or more induction coils winding around the hollow-core fiber.

11. The fiber gas laser apparatus of claim 1 wherein said excitation source is capacitive coupling RF device comprising at least one pair of slab electrodes sandwich the hollow-core fiber in the middle.

12. A fiber ring laser gyro apparatus comprising the fiber gas laser apparatus of claim 1.

13. The fiber ring laser gyro apparatus of claim 12 wherein said fiber ring laser gyro comprises a resonator cavity-length control device comprised of a fiber modulator, a feedback controller, and a fiber compensator.

14. The fiber ring laser gyro apparatus of claim 13 wherein said fiber modulator and said fiber compensator use the same piezoelectric transducer with fiber around it.

15. The fiber ring laser gyro apparatus of claim 13 wherein said fiber modulator and said fiber compensator use two separate piezoelectric transducers with fibers winding around them.

16. The fiber ring laser gyro apparatus of claim 12 wherein said fiber ring laser gyro also includes a beat frequency read out device.

17. The fiber ring laser gyro apparatus of claim 16 wherein said beat frequency read out device comprises a 3×3 coupler and three photo-detectors connected to three output ends of the coupler.
